(19) United States
(12) Patent Application Publication
(10) Pub. No.: US 2026/0027944 A1
(43) Pub. Date: Jan. 29, 2026

(54) Methods and Systems for Operating a Battery Pack

(71) Applicant: Accelerated Systems Inc., Waterloo (CA)

(72) Inventors: Willem Jager, Cambridge (CA); Josh Wilson, Random Lake, WI (US)

(73) Assignee: Accelerated Systems Inc., Waterloo, ON (CA)

(21) Appl. No.: 19/283,127

(22) Filed: Jul. 28, 2025

Related U.S. Application Data
(60) Provisional application No. 63/676,621, filed on Jul. 29, 2024.

(51) Int. Cl. B60L 58/13; B60L 50/60

(52) U.S. Cl. CPC B60L 58/13; B60L 50/60; B60L 2200/22; B60L 2240/549

(57) ABSTRACT

An electric vehicle includes an active battery pack for operating the electric vehicle, and a controller for operating the electric vehicle with an emulated performance based on a reference battery pack. The emulated performance includes: obtaining a state of charge of the active battery pack; obtaining an available current of the active battery pack based on the state of charge; and limiting an operating current of the active battery pack to be less than the available current. The operating current corresponds to a reference current of the reference battery pack based on the state of charge. The reference battery pack may include a lead-acid battery. The active battery pack may include an iron-phosphate battery or a lithium-ion battery.

### RELATED APPLICATIONS

This application claims priority to U.S. Provisional App. No. 63/676,621, filed Jul. 29, 2024 and entitled “Methods and Systems for Operating a Battery Pack”, the entire contents of which are hereby incorporated by reference herein for all purposes.

### TECHNICAL FIELD

The present specification relates to methods and systems for operating a battery pack, and in particular to methods and systems for operating a battery pack used to power an electric vehicle.

### INTRODUCTION

The following paragraphs are not an admission that anything discussed in them is prior art or part of the knowledge of persons skilled in the art.

Many vehicles have a power source to provide the power used to operate the vehicle. In some vehicles, electric power may be used to provide the motive power for the vehicle. Such vehicles may be described as electric vehicles. Some electric vehicles may be powered by a battery pack.

### SUMMARY

In this specification, elements may be described as “to” perform one or more functions, “configured to” perform one or more functions, or “configured for” such functions. In general, an element that is to perform, configured to perform, or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” can be construed as X only, Y only, Z only, or any combination of two or more items X, Y, and Z (e.g., XYZ, XY, YZ, ZZ, and the like). Similar logic can be applied for two or more items in any occurrence of “at least one . . . ” and “one or more . . . ” language.

In one general aspect, there is provided a method of operating a target battery pack, the method comprising: obtaining at a controller a state of charge (SoC) of the target battery pack; obtaining at the controller an available current of the target battery pack corresponding to the SoC; determining at the controller that the SoC is less than a full SoC of the target battery pack; and controlling an operating current of the target battery pack based on the SoC to be less than the available current.

A reference battery pack may have a corresponding available power that decreases according to a discharge power profile based on decreases in a corresponding SoC of the reference battery pack; and the controlling the operating current of the target battery pack may comprise reducing the operating current of the target battery pack to less than the available current based on the SoC according to the discharge power profile of the reference battery pack to allow the target battery pack to emulate the discharge power profile of the reference battery pack.

The reference battery pack may comprise a lead-acid battery; and the target battery pack may comprise one or more of an iron-phosphate battery and a lithium-ion battery.

The controlling the operating current of the target battery pack may comprise the controller controlling one or more electronic switches to control the operating current of the target battery pack.

The controlling the operating current of the target battery pack may comprise the controller communicating a magnitude of the operating current to another component of a system to be powered by the target battery pack, the component to demand current from the target battery pack based on the magnitude of the operating current.

The system may comprise an electric vehicle.

The target battery pack may be to power an electric vehicle; and the method may further comprise: determining at the controller that the SoC of the target battery pack is equal to or less than a threshold SoC; reducing the operating current to a reduced current for a predetermined time period, the reduced current being less than a minimum current for the electric vehicle to move; and after passage of the predetermined time period, at least partially restoring the operating current to equal or exceed the minimum current.

According to another aspect of the present specification, there is provided a controller for operating a target battery pack, the controller comprising: a memory to store instructions executable by a processor; and a processor in communication with the memory, the processor to: obtain a state of charge (SoC) of the target battery pack; obtain an available current of the target battery pack corresponding to the SoC; determine that the SoC is less than a full SoC of the target battery pack; and control an operating current of the target battery pack based on the SoC to be less than the available current.

A reference battery pack may have a corresponding available power that decreases according to a discharge power profile based on decreases in a corresponding SoC of the reference battery pack; and to control the operating current of the target battery pack the processor may be to reduce the operating current of the target battery pack to less than the available current based on the SoC according to the discharge power profile of the reference battery pack to allow the target battery pack to emulate the discharge power profile of the reference battery pack.

The reference battery pack may comprise a lead-acid battery; and the target battery pack may comprise one or more of an iron-phosphate battery and a lithium-ion battery.

To control the operating current of the target battery pack the processor may be to control one or more electronic switches to control the operating current of the target battery pack.

To control the operating current of the target battery pack the processor may be to communicate a magnitude of the operating current to another component of a system to be powered by the target battery pack, the component to demand current from the target battery pack based on the magnitude of the operating current.

The system may comprise an electric vehicle.

The target battery pack may be to power an electric vehicle; and the processor may be further to: determine that the SoC of the target battery pack is equal to or less than a threshold SoC; reduce the operating current to a reduced current for a predetermined time period, the reduced current being less than a minimum current for the electric vehicle to move; and after passage of the predetermined time period, at least partially restore the operating current to equal or exceed the minimum current

Other aspects and features will become apparent, to those ordinarily skilled in the art, upon review of the following description of some exemplary embodiments.

In one general aspect, there is a method of operating an electric vehicle with an emulated performance based on a reference battery pack. The emulated performance may include: obtaining a state of charge of an active battery pack that operates the electric vehicle; obtaining an available current of the active battery pack based on the state of charge; and limiting an operating current of the active battery pack to be less than the available current. The operating current may correspond to a reference current of the reference battery pack based on the state of charge. Other embodiments of this aspect include corresponding computer systems, apparatus, and computer programs recorded on one or more computer storage devices, each configured to perform the actions of the methods.

Implementations may include one or more of the following features. The operating current of the active battery pack may be limited for a predetermined time period to less than a minimum current for the electric vehicle to move resulting in a pause-in-movement. After the predetermined time period, the method may at least partially restore the operating current to at least equal the minimum current. The reference battery pack may be of a different battery type than the active battery pack. The reference battery pack may include a lead-acid battery. The active battery pack may include at least one of an iron-phosphate battery and a lithium-ion battery. The operating current of the active battery pack may be limited to emulate a discharge power profile of the reference battery pack. The operating current of the active battery pack may be limited if the state of charge of the active battery pack is less than a threshold state of charge. The threshold state of charge may be less than 20% of a full state of charge.

Some embodiments may include corresponding computer systems, apparatus, and computer programs recorded on one or more computer storage devices, each configured to perform the actions of the methods.

In one general aspect, there is a controller for operating an electric vehicle having an active battery pack. The controller may include: a memory for storing a reference current of a reference battery pack; and a processor for operating the active battery pack with an emulated performance based on the reference battery pack. The emulated performance may include: obtaining a state of charge of the active battery pack; obtaining an available current of the active battery pack based on the state of charge; and limiting an operating current of the active battery pack to be less than the available current. The operating current may correspond to the reference current of the reference battery pack based on the state of charge.

Implementations may include one or more of the following features. The operating current of the active battery pack may be limited for a predetermined time period to less than a minimum current for the electric vehicle to move resulting in a pause-in-movement. After the predetermined time period, the controller may at least partially restore the operating current to at least equal the minimum current. The reference battery pack may be of a different battery type than the active battery pack. The reference battery pack may include a lead-acid battery. The active battery pack may include at least one of an iron-phosphate battery and a lithium-ion battery. The operating current of the active battery pack may be limited to emulate a discharge power profile of the reference battery pack. The operating current of the active battery pack may be limited if the state of charge of the active battery pack is less than a threshold state of charge. The threshold state of charge may be less than 20% of a full state of charge.

In one general aspect, there is electric vehicle. The electric vehicle may include an active battery pack for operating the electric vehicle; and a controller for operating the electric vehicle with an emulated performance based on a reference battery pack. The emulated performance may include: obtaining a state of charge of the active battery pack; obtaining an available current of the active battery pack based on the state of charge; and limiting an operating current of the active battery pack to be less than the available current. The operating current may correspond to a reference current of the reference battery pack based on the state of charge. Other embodiments of this aspect include corresponding computer systems, apparatus, and computer programs recorded on one or more computer storage devices, each configured to perform the actions of the methods.

Implementations may include one or more of the following features. The operating current of the active battery pack may be limited for a predetermined time period to less than a minimum current for the electric vehicle to move resulting in a pause-in-movement. After the predetermined time period, the controller may at least partially restore the operating current to at least equal the minimum current. The reference battery pack may be of a different battery type than the active battery pack. The operating current of the active battery pack may be limited to emulate a discharge power profile of the reference battery pack.

Implementations of the described techniques may include hardware, a method or process, or a computer tangible medium.

### BRIEF DESCRIPTION OF THE DRAWINGS

The drawings included herewith are for illustrating various examples of articles, methods, and apparatuses of the present specification. In the drawings:

FIG. 1 shows example discharge power profiles for two different types of batteries.

FIG. 2 shows a flowchart depicting an example method of operating a battery pack.

FIG. 3 shows a block diagram of an example controller.

FIG. 4 shows a schematic diagram of an electric vehicle including an active battery pack and a controller.

### DETAILED DESCRIPTION

Various apparatuses or processes will be described below to provide exemplary embodiments. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed below that is not claimed in this document may be the subject matter of another protective instrument, for example, a continuing patent application, and the applicants, inventors or owners do not intend to abandon, disclaim or dedicate to the public any such invention by its disclosure in this document.

Electrical devices or systems may be powered by battery packs. In some examples, a battery pack may comprise one or more batteries or battery cells. Moreover, in some examples, a battery pack may comprise one or more additional components such as connectors, sensors, controllers, and the like. In this description, battery pack is used interchangeably with a battery. In other words, in this description, battery pack may refer to a single battery cell, and may also refer to a plurality of battery cells with or without one or more additional components such as connectors, sensors, controllers, and the like. Functionally, battery pack refers to a portable source of electrical power for an electrical system or device, such as an electric vehicle, and the like.

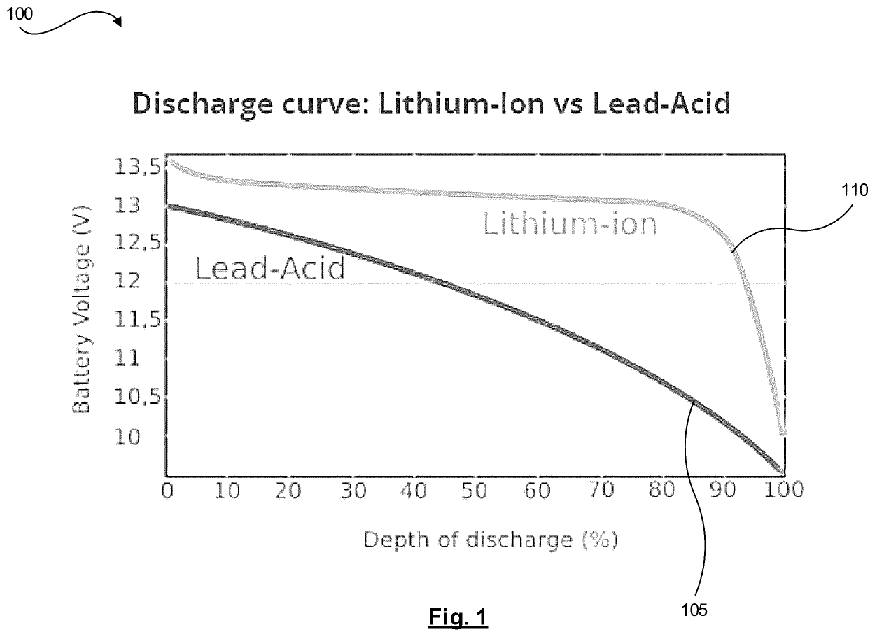

Battery packs may be of different types, with each type having a corresponding battery design and battery chemistry. As such, different types of battery packs may have different discharge power profiles. Discharge power profile refers to how the power delivered by a battery pack varies as its state of charge (SoC) decreases. Since electrical power is a product of voltage and current, changes in electrical power may comprise changes in one or both of voltage and current provided by the battery pack during discharge. FIG. 1 shows a graph 100 of an example discharge power profile 105 for a lead-acid battery and an example discharge power profile 110 for a lithium-ion battery.

As shown in FIG. 1, for a lead-acid battery the voltage (and by extension power) available from the battery declines steadily as the battery continues to discharge. In contrast, for a lithium-ion battery, the voltage (and by extension power) available from the battery remains relatively constant for a large portion of the discharge cycle, and then the power drops rapidly near the end of the discharge cycle. Iron-phosphate batteries may have a discharge power profile similar to lithium-ion batteries. These differences in the discharge power profiles of different types of batteries may lead to differences in the user experiences of operators operating systems powered by the different types of batteries.

For example, historically lead-acid batteries were used to power electric vehicles such as golf carts, and the like. As the operator drove the golf cart, the SoC of the battery would drop, with a corresponding drop in the power available from the battery. The operator would experience this drop in power as a drop in the performance of the golf cart, such as its torque, acceleration, top speed, and the like. This drop in performance would, in turn, signal to the operator that the golf cart would soon need to be charged. Such feedback may be described as a vehicle performance-based SoC indication. In addition, pausing operation of a lead-acid battery powered golf cart would allow the battery power to “partially recover” and for the operator to “limp home” to charge the golf cart.

The power source for some electric vehicles has been changing from lead-acid to lithium-ion or iron-phosphate battery types. The reason for this change may be based on a variety of factors such as cost, performance, environmental considerations, and the like. A side effect of such a switch from lead-acid to lithium-ion or iron-phosphate battery types is that the operators accustomed to having the performance-based SoC indications and the partial-recovery/limp-home options provided by lead-acid batteries may no longer have such SoC indications and limp-home options with lithium-ion or iron-phosphate battery powered electric vehicles.

In order to provide operators of lithium-ion or iron-phosphate battery powered electric vehicles performance-based SoC indications and partial-recovery/limp-home options similar to those provided by lead-acid batteries, the behavior of lithium-ion or iron-phosphate batteries may be made to emulate that of lead-acid batteries. For example, the discharge power profile and/or the partial-recovery characteristics of lithium-ion or iron-phosphate batteries may be made to emulate the discharge profile or the partial-recovery of lead-acid batteries. In general, the performance of an active battery pack of a first type (also referred to as a “target battery pack”) may be made to emulate the performance of a reference battery pack of a second type.

Accordingly, some embodiments herein describe methods of operating an active battery pack with an emulated performance of a reference battery pack. The reference battery pack may be of a different battery type than the active battery pack. For example, the active battery pack may be of a first battery type (e.g. lithium-ion or iron-phosphate) and the reference battery pack may be of a second battery type (e.g. lead-acid). In some embodiments, the method may be used to operate an electric vehicle with emulated performance based on the reference battery pack.

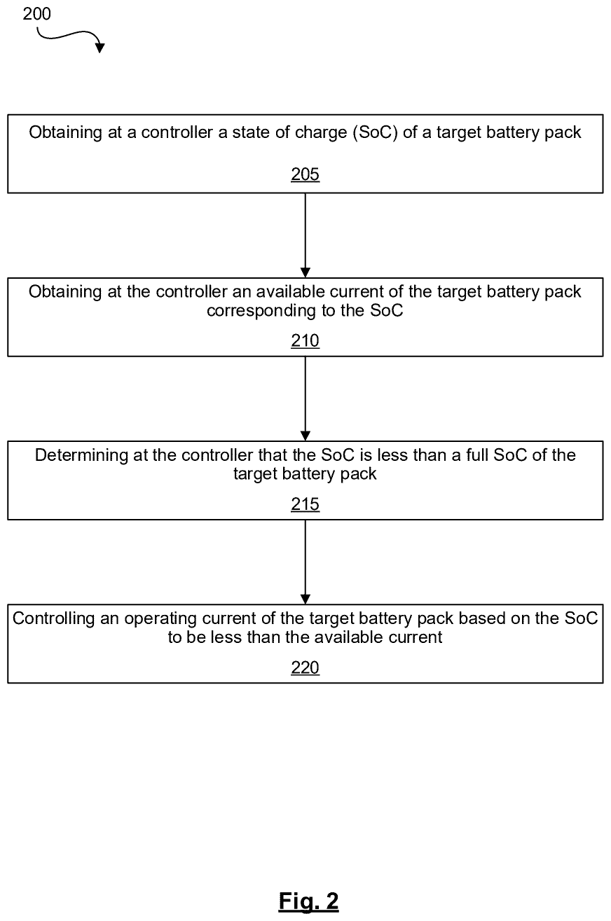

FIG. 2 shows a flowchart of an example method 200 for operating an active battery pack. In some examples, method 200 may be used to allow the performance of the active battery pack to emulate the performance of a reference battery pack. Example characteristics of such emulated performance may include the discharge power profile (which makes possible performance-based SoC indications, and the like), partial-recovery upon pause in use, and the like.

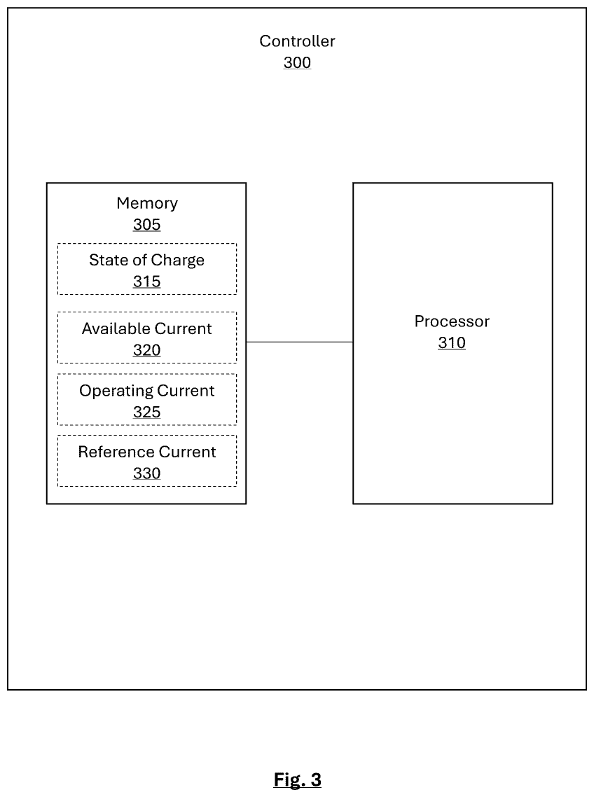

At box 205 of FIG. 2, the SoC of the active battery pack may be obtained at the controller. In some examples, the controller may be the controller 300 (described in greater detail in relation to FIG. 3). It is also contemplated that in some examples, the controller may be different than the controller 300. In some examples, the controller may obtain the SoC by measuring it or by receiving it from the active battery pack. It is also contemplated that in some examples, the controller may obtain the SoC indirectly, for example by receiving it from another component or system.

At box 210, an available current of the active battery pack may be obtained at the controller. The available current may correspond to the SoC. The available current may reflect the amount of current that can be drawn from the active battery pack within its operating parameters and for the given SoC. Examples of such operating parameters may include safety margins, temperature, and the like. In other words, available current may reflect the maximum current that can be drawn from the battery given its operating parameters and SoC. The controller may determine the available current itself, or may obtain the value of available current indirectly, for example by receiving it from another component or system.

Moreover, at box 215 the controller may determine that the SoC is less than a full state of charge (full SoC) of the active battery pack. In this context, full SoC may be based on the operating parameters of the battery pack, such as preferred charge/discharge cycles, temperature, and the like. In other words, while in some examples full SoC may represent an about 100% charge, it is also contemplated that in some examples full SoC may be less than 100% charge based on operating parameters of the active battery pack. Determining that the SoC is less than the full SoC may comprise the controller comparing the SoC to the full SoC, and determining if the SoC is less than the full SoC.

Furthermore, at box 220 the controller may control the operating current of the active battery pack based on the SoC to be less than the available current. Operating current may reflect how much current can be drawn from the active battery pack in operation. In other words, once the SoC has determined at box 215 the SoC to be less than full SoC, the controller may control the operating current to be less than the available current. In some examples, in this manner the operating current (and by extension power) of the active battery pack may be allowed to emulate a reference battery pack whose available power decreases in operation as its SoC decreases.

In some examples, such a reference battery pack may have a corresponding available power that decreases according to a discharge power profile based on decreases in the corresponding SoC of the reference battery pack. In such examples, controlling the operating current of the active battery pack may include reducing the operating current of the active battery pack to less than the available current based on the SoC according to the discharge power profile of the reference battery pack. This, in turn, may allow the active battery pack to emulate the discharge power profile of the reference battery pack. In addition, in some examples, the reference battery pack may comprise a lead-acid battery. Moreover, in some examples, the active battery pack may comprise one or more of an iron-phosphate battery and a lithium-ion battery. Other types of active and reference battery packs are also contemplated.

In addition, in some examples the controller may comprise, or may control, electronic switches that control the current drawn from the active battery pack. In such examples, controlling the operating current of the active battery pack may comprise the controller controlling the electronic switches to control the operating current of the active battery pack.

In some examples, the current drawn from the active battery pack may be gated by an on-off contactor. Such a contactor may not be able to gradually or incrementally control the amount of operating current drawn from the active battery pack. In such examples, controlling the operating current of the active battery pack may include the controller communicating a magnitude of the operating current to another component of a system to be powered by the active battery pack. The component may then demand current from the active battery pack based on the magnitude of the operating current. In other words, in such examples the controller may determine the amount or magnitude of the operating current. The components demanding operating current from the active battery pack may then adjust how much operating current they demand based on this magnitude.

Examples of such components may include electric motors or other electric actuators, electric heaters, and the like. Examples of the system being powered by the active battery pack may include an electric vehicle, such as a golf cart, and the like. While some of the examples described herein are in the context of electric vehicles, it is contemplated that in some examples, the methods and controllers described herein may be used in other systems and devices powered by battery packs, such as electric equipment, electric tools, backup electrical storage, and the like.

In addition, in some examples, the methods and controllers described herein may allow the active battery pack to emulate a “partial recovery” behavior, such as a partial recovery behavior of a reference battery pack. In an example where the active battery pack is used to power an electric vehicle, method 200 may further comprise determining at the controller that the SoC of the active battery pack is equal to or less than a threshold state of charge (threshold SoC). This threshold SoC may comprise a threshold SoC at which a pause in operations is to be implemented, to allow for emulation of the partial recovery behavior. In some examples, this threshold SoC may be about 20%, about 10%, about 5%, and the like. The operating current may then be reduced to a reduced current for a predetermined time period, which reduced current may be less than the minimum current for the electric vehicle to move. In other words, the operating current may be reduced sufficiently to immobilize the electric vehicle, to allow for the pause-in-operation/pause-in-movement that is part of the partial-recovery behavior of a reference battery pack, such as a lead-acid battery. The predetermined time period may be between 1-miute and 10-minutes, or more particularly, between 1-miute and 5-minutes.

After passage of the predetermined time period, the operating current may be at least partially restored to being equal or exceeding the minimum current. In other words, after passage of the predetermine time periods, the operating current may be restored sufficiently to allow the vehicle to move again to “limp home” and recharge. The minimum current may be determined based on the electric vehicle, and more specifically, the power demand of the motor or powertrain.

While the partial recovery and “limp home” behaviors described herein are in the context of electric vehicles, it is contemplated that in some examples, the methods and controllers described herein, including their partial recovery and limp home features, may be implemented in other systems and devices powered by battery packs, such as electric equipment, electric tools, backup electrical storage, and the like.

Turning now to FIG. 3, an example controller 300 is shown which may be used for operating an active battery pack. In some examples, the controller may be configured to be secured onboard a system or device being powered by the active battery pack, such as a golf cart or another electric vehicle. In other examples, the controller may be in remote or wireless communication with the system or device being powered by the active battery pack. In addition, in some examples, the controller 300 may be used to perform method 200 and the other methods described herein. The controller 300 comprises a memory 305 in communication with a processor 310. Processor 310 may include a central processing unit (CPU), a graphics processing unit (GPU), a microcontroller, a microprocessor, a processing core, a field-programmable gate array (FPGA), or similar device capable of executing instructions. Moreover, in some examples, processor 310 may comprise a cloud-based processing module, a virtualized processing module, a distributed processing module, a quantum computing module, and the like. Processor 310 may cooperate with memory 305 to execute instructions.

Memory 305 may include a non-transitory machine-readable storage medium that may be an electronic, magnetic, optical, or other physical storage device that stores executable instructions. The machine-readable storage medium may include, for example, random access memory (RAM), read-only memory (ROM), electrically-erasable programmable read-only memory (EEPROM), flash memory, a storage drive, an optical disc, and the like. In some examples, memory 305 may comprise cloud-based storage. The machine-readable storage medium may be encoded with executable instructions. In other words, memory 305 may store instructions executable by processor 310.

Processor 310 may obtain a state of charge (SoC) 315 of the active battery pack, as well as an available current 320 of the active battery pack corresponding to SoC 315. Processor 310 may determine that SoC 315 is less than a full SoC of the active battery pack. In addition, processor 310 may control an operating current 325 of the active battery pack based on SoC 315 to be less than available current 320.

In some examples, the memory 305 may store a reference current for the reference battery pack. For example, a reference battery pack may have a corresponding available power that decreases according to a discharge power profile based on decreases in a corresponding SoC of the reference battery pack. The memory 305 may store the reference current as one or more data points corresponding to discharge power profile. In some such examples, processor 310 may reduce operating current 325 of the active battery pack to less than available current 320 based on SoC 315 according to the reference current or discharge power profile of the reference battery pack.

This may allow the active battery pack to emulate the discharge power profile of the reference battery pack. Furthermore, in some examples, the reference battery pack may comprise a lead-acid battery, and the active battery pack may comprise one or more of an iron-phosphate battery and a lithium-ion battery.

In addition, in some examples, processor 310 may control one or more electronic switches to control operating current 325 of the active battery pack. Moreover, in some examples, processor 310 may communicate a magnitude of operating current 325 to another component of a system to be powered by the active battery pack. The component may be configured to demand current from the active battery pack based on this magnitude of operating current 325. In some examples, the system may comprise an electric vehicle, electric tool, electric equipment, backup electric storage, and the like.

Moreover, in some examples where the active battery pack is to power an electric vehicle, processor 310 may determine that SoC 315 of the active battery pack is equal to or less than a threshold SoC. Processor 310 may reduce operating current 325 to a reduced current for a predetermined time period. The reduced current may be less than the minimum current for the electric vehicle to move. In addition, processor 310 may, after passage of the predetermined time period, at least partially restore operating current 325 to equal or exceed the minimum current.

As described above, in some examples the controller 300 may be used to perform method 200 and the other methods described herein. Furthermore, in some examples, the controller 300 may be used to perform methods and functions different from those described herein in relation to method 200. Moreover, the methods and controllers described herein may include the features and/or perform the functions described herein in association with the other one of the methods and controllers described herein.

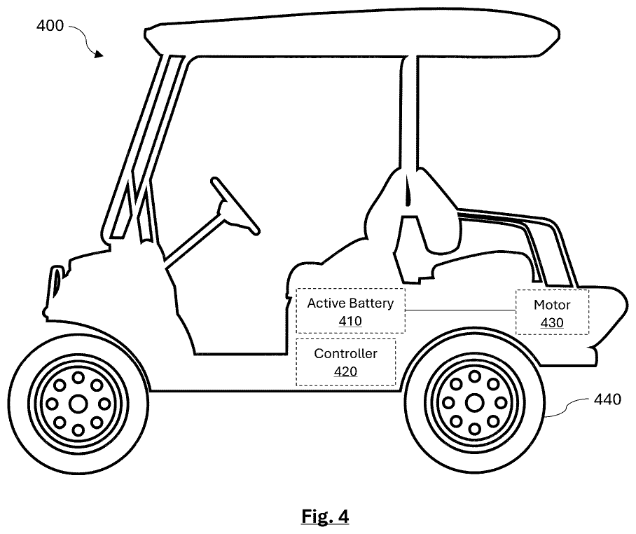

Referring to FIG. 4, there is an electric vehicle 400 such as a golf cart. The electric vehicle includes an active battery pack 410 and a controller 420.

The active battery pack 410 may operate the electric vehicle 400. For example, the active battery pack 410 may operate a motor 430 and wheels 440, or another form of powertrain.

The controller 420 may be similar to the controller 300. The controller 420 may be configured to operate according to the methods described herein such as method 200. For example, the controller 420 may operate the electric vehicle 400 with an emulated performance based on a reference battery pack. The controller 420 may obtain a state of charge of the active battery pack, and obtain an available current of the active battery pack based on the state of charge. The controller 420 may limit an operating current of the active battery pack to be less than the available current. The operating current may correspond to a reference current of the reference battery pack based on the state of charge, such as the discharge power profile of the reference battery pack.

It should be recognized that features and aspects of the various examples provided above can be combined into further examples that also fall within the scope of the present disclosure.

In the preceding description, for purposes of explanation, numerous details are set forth in order to provide a thorough understanding of the embodiments. However, it will be apparent to one skilled in the art that these specific details may not be required. In other instances, well-known structures are shown in block diagram form in order not to obscure the understanding. For example, specific details are not provided as to whether some of the embodiments described herein are implemented as a software routine running on a processor via a memory, hardware circuit, firmware, or a combination thereof.

Embodiments of the disclosure or elements thereof can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

1. A method comprising:
a) operating an electric vehicle with an emulated performance based on a reference battery pack, wherein the emulated performance includes:
i) obtaining a state of charge of an active battery pack that operates the electric vehicle;
ii) obtaining an available current of the active battery pack based on the state of charge; and
iii) limiting an operating current of the active battery pack to be less than the available current, wherein the operating current corresponds to a reference current of the reference battery pack based on the state of charge.

2. The method of claim 1, wherein the operating current of the active battery pack is limited for a predetermined time period to less than a minimum current for the electric vehicle to move resulting in a pause-in-movement, and after the predetermined time period, at least partially restoring the operating current to at least equal the minimum current.

3. The method of claim 1, wherein the reference battery pack is of a different battery type than the active battery pack.

4. The method of claim 3, wherein the reference battery pack comprises a lead-acid battery.

5. The method of claim 3, wherein the active battery pack comprises at least one of an iron-phosphate battery and a lithium-ion battery.

6. The method of claim 1, wherein the operating current of the active battery pack is limited to emulate a discharge power profile of the reference battery pack.

7. The method of claim 1, wherein the operating current of the active battery pack is limited if the state of charge of the active battery pack is less than a threshold state of charge.

8. The method of claim 7, wherein the threshold state of charge is less than 20% of a full state of charge.

9. A controller for operating an electric vehicle having an active battery pack, the controller comprising:
a) a memory for storing a reference current of a reference battery pack; and
b) a processor for operating the active battery pack with an emulated performance based on the reference battery pack, wherein the emulated performance includes:
i) obtaining a state of charge of the active battery pack;
ii) obtaining an available current of the active battery pack based on the state of charge; and
iii) limiting an operating current of the active battery pack to be less than the available current, wherein the operating current corresponds to the reference current of the reference battery pack based on the state of charge.

10. The controller of claim 9, wherein the operating current of the active battery pack is limited for a predetermined time period to less than a minimum current for the electric vehicle to move resulting in a pause-in-movement, and after the predetermined time period, at least partially restoring the operating current to at least equal the minimum current.

11. The controller of claim 9, wherein the reference battery pack is of a different battery type than the active battery pack.

12. The controller of claim 11, wherein the reference battery pack comprises a lead-acid battery.

13. The controller of claim 11, wherein the active battery pack comprises at least one of an iron-phosphate battery and a lithium-ion battery.

14. The controller of claim 9, wherein the operating current of the active battery pack is limited to emulate a discharge power profile of the reference battery pack.

15. The controller of claim 9, wherein the operating current of the active battery pack is limited if the state of charge of the active battery pack is less than a threshold state of charge.

16. The controller of claim 15, wherein the threshold state of charge is less than 20% of a full state of charge.

17. An electric vehicle comprising:
a) an active battery pack for operating the electric vehicle; and
b) a controller for operating the electric vehicle with an emulated performance based on a reference battery pack, wherein the emulated performance includes:
i) obtaining a state of charge of the active battery pack;
ii) obtaining an available current of the active battery pack based on the state of charge; and
iii) limiting an operating current of the active battery pack to be less than the available current, wherein the operating current corresponds to a reference current of the reference battery pack based on the state of charge.

18. The electric vehicle of claim 17, wherein the operating current of the active battery pack is limited for a predetermined time period to less than a minimum current for the electric vehicle to move resulting in a pause-in-movement, and after the predetermined time period, at least partially restoring the operating current to at least equal the minimum current.

19. The electric vehicle of claim 17, wherein the reference battery pack is of a different battery type than the active battery pack.

20. The electric vehicle of claim 17, wherein the operating current of the active battery pack is limited to emulate a discharge power profile of the reference battery pack.
